(19) United States
(12) Patent Application Publication
(10) Pub. No.: US 2016/0125421 A1
(43) Pub. Date: May 5, 2016

(54) SYSTEM FOR LICENSE DATA ANALYSIS AND PROCESSING

(71) Applicant: HARTFORD FIRE INSURANCE COMPANY, Hartford, CT (US)

(72) Inventors: Lisa LEVIN, Avon, CT (US); Barbara J. LECLAIR, New Britain, CT (US); Mary Bramble SCOTT, West Hartford, CT (US)

(73) Assignee: HARTFORD FIRE INSURANCE COMPANY, Hartford, CT (US)

(21) Appl. No.: 14/527,500

(22) Filed: Oct. 29, 2014

(51) Int. Cl. G06Q 30/00

(52) U.S. Cl. CPC G06Q 30/018

(57) ABSTRACT

This invention relates to a computer system for the compilation, tracking and aggregation of entity data to centralize licensing information in a single repository for use by various entities to ensure compliance and expedite information retrieval and access across an enterprise.

### BACKGROUND

State and federal regulations govern many businesses and the way in which those businesses conduct their daily operations and interact with customers. The insurance industry for one is a highly regulated business and insurance companies are legally required to maintain licenses for all of its legal entities in each jurisdiction where they operate. A typically large insurance company may have many legal entities operating in some or all of the 50 states and various territories, resulting in potentially thousands of license filings annually. The license type is determined by the nature and type of business conducted by each entity. The license may vary and may include: 1) insurance licenses authorizing certain entities to issue insurance products; 2) agency licenses authorizing entities to solicit, sell, and offer insurance products; 3) business licenses (also referred to as “annual reports”) qualifying foreign entities to do business in states in which the entity is not incorporated; and 4) third party administrator licenses authorizing performance of administrative services to self-insured clients and insurers not affiliated with an insurance entity.

These licenses are critical for the day to day operation and livelihood of insurance entities and their parent companies. In addition, efficient, reliable and accurate entity license management helps ensure regulatory compliance and reduces corporate risk. Accordingly, there is a need for a system that accurately, efficiently and reliably tracks license information for insurance entities, agents, businesses and third party administrators in a centralized manner with an intuitive user interface.

### SUMMARY

The present invention in some embodiments relates to a computer system for processing and tracking entity license input data with a third party data system, comprising: one or more data storage devices storing data indicative of entity license compliance guidelines for a plurality of jurisdictions and entity license data for a plurality of related entities; one or more computer processors; and a memory storing computer-readable instructions, which instructions, when executed by the one or more computer processors, cause the one or more computer processors to: periodically determine if one or more licensed entities have entered a period of license renewal; output a validated notification related to the one or more licensed entities that have entered the period of license renewal; output an entity license data user interface including a plurality of data fields for entry and viewing of entity license data for display on a display device; validate a user for proper access credentials; receive first data associated with at least one licensed entity in at least one jurisdiction via the user interface for the validated user; retrieve entity compliance guidelines applicable to the claim from the one or more data storage devices, based on the first data; modify an electronic record associated with the at least one licensed entity; populate one or more data fields included in the user interface with updated data related to the at least one licensed entity; and schedule at least one future notification based on the populated data fields.

The present invention in some embodiments is a computer-implemented method for generating and displaying one or more interactive user interfaces for entity renewal tracking, comprising: outputting by one or more computer processors to a display device an entity renewal data collection user interface including a plurality of data fields for entry of information about an entity renewal for display on a display device; receiving, by the one or more computer processors, first data associated with the entity renewal via the user interface; retrieving, by the one or more computer processors, from one or more data storage devices storing data indicative of entity renewal guidelines for a plurality of jurisdictions; issuing, by the one or more computer processors, a renewal notification to one or more authorized entities; determining, by the one or more computer processors, from the one or more data storage devices, filing requirements for the one or more entity renewals; receiving, by the one or more computer processors, data from one or more users via the user interface; populating, by the one or more computer processors, one or more renewal related forms via the user interface; requesting, by the one or more processors, payment data related to the one or more renewal related forms; submitting, by the one or more computer processors, the populated renewal forms and payment data to one or more third party systems; and adjusting, by the one or more computer processors, one or more entity records based on the submitted forms and data.

The present invention in some embodiments relates to a computer system for generating and displaying one or more entity renewal forms and processing renewal input data, comprising a renewal processing user terminal; a first computer system in communication with the renewal processing terminal, the first computer system comprising: one or more data storage devices storing data indicative of entity renewal guidelines for a plurality of jurisdictions; one or more computer processors; and a memory storing computer-readable instructions, which instructions, when executed by the one or more computer processors, cause the one or more computer processors to: output an entity renewal data collection user interface including at least one data field for input of information about an entity renewal for display on a display device of at least one of the renewal processing terminal; validate a user for the entity renewal data collection user interface; receive third party renewal data from the validated user for a specific license type; validate third party renewal data; determining renewal filing requirements; receive renewal data via the user interface; request renewal payment data; submit renewal data and payment data to a third party system; and validate renewal data and payment data.

### BRIEF DESCRIPTION OF THE DRAWINGS

A more detailed understanding may be had from the following description, given by way of example in conjunction with the accompanying drawings wherein:

FIG. 1 shows an exemplary computer architecture of the present invention;

FIG. 2 shows an exemplary computer system of the present invention;

FIG. 3 shows an exemplary system network of the present invention;

FIG. 4 shows an exemplary process flow of the present invention;

FIG. 5 shows an exemplary data layout of an embodiment of the present invention;

FIG. 6 shows an exemplary data structure of an embodiment of the present invention;

FIG. 7 shows another exemplary data structure of an embodiment of the present invention;

FIG. 8 shows another exemplary data structure of an embodiment of the present invention;

FIG. 9 shows a graphical user interface of an embodiment of the present invention; and

FIG. 10 shows another computerized method of the present invention.

### DETAILED DESCRIPTION

Disclosed herein are processor-executable methods, computing systems, and related technologies for achieving efficiencies in connection with enterprise license management and tracking, and particularly processing and access of entity license data across various states and territories. Entity licensure is critical for insurance companies as they are legally required to maintain entity licenses in each jurisdiction where they offer, solicit and sell insurance. These entities are licensed by each state to sell and distribute insurance products in each state and an insurance company cannot legally do so without having an active license in each state. Poorly managed entity licensure procedures results in significant inefficiencies, as well as potentially substantial fines and other regulatory risk. Management and administration of such license data involves complicated and data intensive computer processing, including maintaining and updating records concerning thousands of records that must be updated frequently due to such factors as frequent changes in state licensure requirements, business processes, strategies and other factors. The present description provides a dynamic centralized electronic risk management and intelligence system for the state/territory license filings for insurance writing companies and all other related entities. The system services business segments and others in the enterprise who need to know where certain entities are authorized to write insurance and for what lines of business. The system allows an entity, such as an insurance entity, to manage its most urgent business risks across operational risk areas such as finance, legal, operations, resiliency, and IT/security through the system.

This patent application discusses four principal types of entity licenses: 1. Insurance Licenses that are for entities that underwrite and issue policies of insurance. The insurance license is generally referred to as the Certificate of Authority (“COA”), which is issued by Departments of Insurance to underwrite and issue policies of insurance. COAs are generally required for all insurance writing companies. 2. Agency Licenses that are for entities that solicit, sell, and offer insurance products. Agency licenses can also be referred to as “Producer” licenses, which are issued by the Departments of Insurance to solicit, sell, and offer insurance products through our agencies. 3. Business Licenses (also referred to as “annual reports”) authorize a non-writing company or LLC to conduct business in a state outside of the state of incorporation/organization. Business licenses are issued by the Secretaries of the State offices and are required for all non-writing companies and in dual-filing jurisdictions for writing companies. 4. Third Party Administrator Licenses that are for entities that provide administrative services to self-insurers and other insurers not affiliated with the insurance entity. Third Party Administrator licenses are issued by the Departments of insurance of each. respective state.

in some embodiments, the present invention may be utilized to select writing companies in which to provide new insurance products or write new business as well as to process renewals for existing writing company entities. Factors such as uniformity and consistency among different jurisdictions, amounts of premium already written and for what line of business, tax considerations and other factors may be used to optimize selection of a writing company. For example, it may be desirable to file for a brand new writing entity as opposed to utilize an existing writing company based on the product being introduced. Conversely, if an existing entity is used, it would he desirable to effect the license renewals to enable the new product to be offered in those jurisdictions.

The present embodiments provide significant technical improvements to entity license data tracking and processing technology. The present embodiments are directed to more than merely a computer implementation of a routine or conventional activity previously known in the industry as it significantly advances the technical efficiency, access and/or accuracy of entity license data tracking processing by implementing a specific new method and system as defined herein. The present embodiments include systems and methods to implement interactions of types not previously known in the art between specialized computer systems. The present embodiments provide specific advancement in the area of entity license data tracking by providing technical benefits in data accuracy, data availability and data integrity, as well as benefits in efficiency of use of data processing, storage and processing resources, and such advances are not merely a longstanding commercial practice. The present embodiments provide improvement beyond a mere generic computer implementation as it involves the processing and conversion of significant amounts of data in a new beneficial manner as well as the interaction of a variety of specialized insurance, client and/or vendor systems, networks and subsystems.

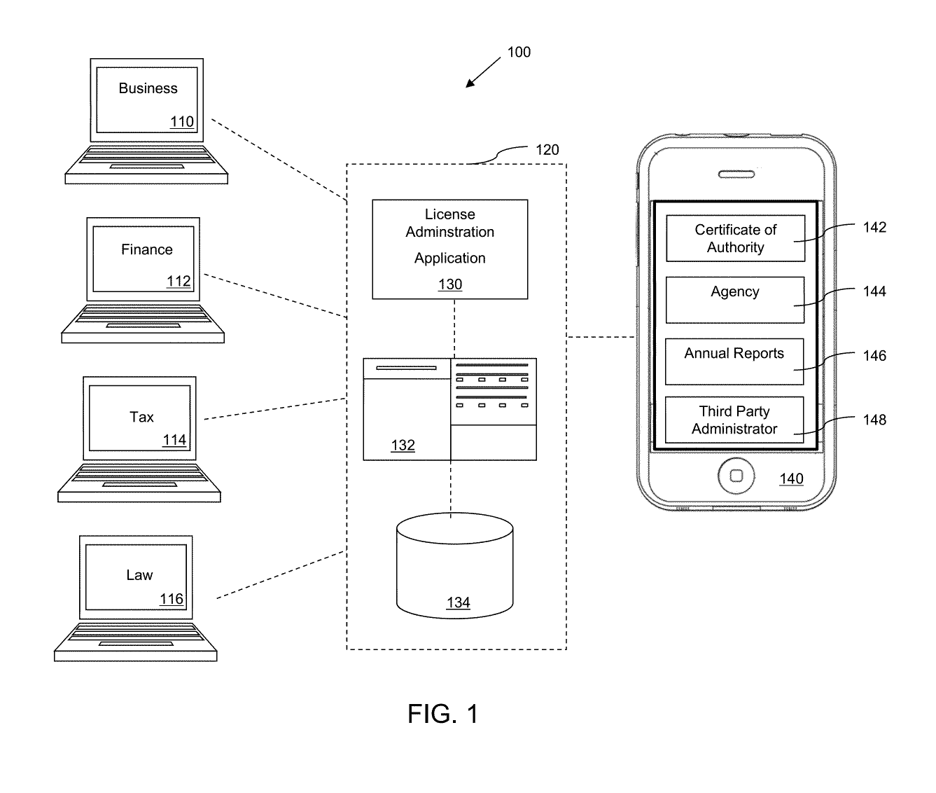

Features of some embodiments will now be described by first referring to FIG. 1 which illustrates a system 100 within which some embodiments may be implemented. More particularly, FIG. 1 depicts a system 100 in which entity licenses may be recorded, processed, tracked and managed. Although the devices of system 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example architecture shown in FIG. 1, one or more requestor or devices 110, 112, 114 and 116 are provided which comprise devices that may be operated by a user such as an insurance company employee or agent seeking to view, track and manage entity license data. Devices 110, 112, 114 and 116 are associated with one or more insurance related entities or departments such as a business entity or department, a finance entity or department, a tax entity or department and a legal entity or department. In other embodiments, each of the entity or departments may be combined or sub-combined and other departments may exist for operating devices 110, 112, 114, and 116. In one example, a Corporate Law Department, Statutory Reporting, Tax, and a Property and Casualty Unit of an insurance company may have individual and/or shared responsibility for various entity license responsibilities including the filing, maintenance, renewal and administration of such entity licenses across an entire enterprise.

Devices 110, 112, 114, and 116 may interact with insurance system 120 that operates or controls a license administration application 130 running on a server 132. Web based pages are provided by a Web server 134 to devices 110, 112, 114, and 116, such as user device and user operating devices, to enable users to request entity license data, view entity license data, provide or impute entity license data, etc. Server 132 may include a web application module and a HyperText Transfer Protocol (HTTP) server module. The web application module may generate the web pages that make up the web site and that are communicated by the HTTP server module. Web application module may be implemented in and/or based on a technology such as Active Server Pages (ASP), PHP: Hypertext Preprocessor (PHP), Python/Zope, Ruby, any server-side scripting language, and/or any other appropriate technology.

The HTTP server module may implement the HTTP protocol, and may communicate HyperText Markup Language (HTML) pages and related data from the web site to/from client devices using HTTP. The HTTP server module may be, for example, a Sun-ONE Web Server, an Apache HTTP server, a Microsoft Internet Information Services (IIS) server, and/or may be based on any other appropriate HTTP server technology. The web site system may also include one or more additional components or module, such as one or more switches, load balancers, firewall devices, routers, and devices that handle power backup and data redundancy.

Server 132 may also be in communication with a database or data warehouse for storing entity license data, compliance guidelines and other related licensure information. Any number or type of data storage systems may store the data in any suitable manner according to some embodiments. Non-exhaustive examples include a relational database system, a spreadsheet, and any other data structure that is amenable to parsing and manipulating data. Data warehouse may be managed by one or more database management systems which may be based on a technology such as Microsoft SQL Server, MySQL, Oracle Relational Database Management System (RDBMS), PostgreSQL, a NoSQL database technology, and/or any other appropriate technology.

System 100 may also include one or more access devices 140 for accessing entity license information. Any number of access devices 140 may be employed to view, edit, input and manage entity license data. Requestor devices may include but are not limited to cellular telephones, handheld wireless communication devices, personal digital assistants, pagers, laptop computers, tablet computers, smartphones, other mobile display devices; glasses based computing devices, or combinations thereof.

In some embodiments, insurance system 120 may include an insurance workflow computer. In embodiments, an insurance workflow computer system may be configured to receive data indicative of the electronic communication issued to the requestor terminal, and to determine one or more insurance-related workflow modifications in response to receipt of the data indicative of the electronic communication. Insurance-related workflow modifications may include notifying agents or third party administrators of entity license related information.

It should be noted that embodiments are not limited to the devices illustrated in FIG. 1. Each device may include any number of disparate hardware and/or software elements, some of which may be located remotely from one another. Functions attributed to one device may be performed by one or more other devices in some embodiments. The devices of system 100 may communicate with one another (and with other non-illustrated elements) over any suitable communication media and protocols that are or become known.

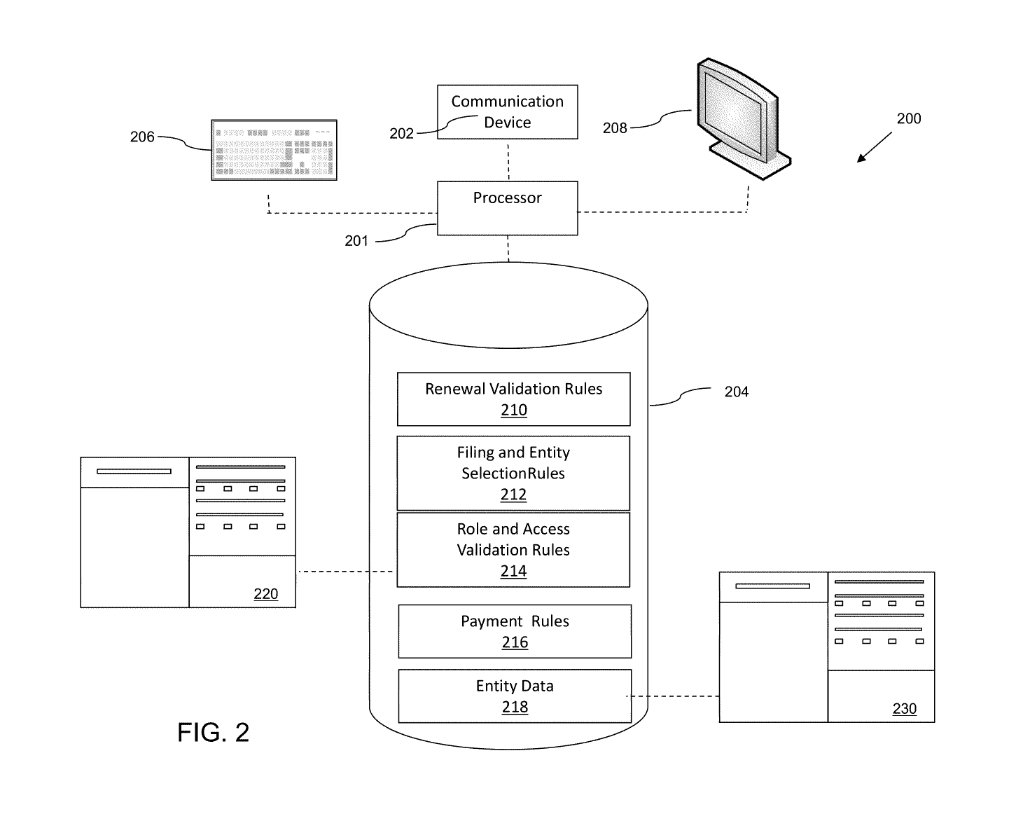

FIG. 2 is a block diagram of a computer system 200 according to some embodiments. Computer system 200 may perform the functions attributed above to the insurance system 120 of FIG. 1. Computer system 200 includes computer processor 201 operatively coupled to communication device 202, data storage device 204, one or more input devices 206 and one or more output devices 208. Communication device 202 may facilitate communication with external devices. Input device(s) 206 may comprise, for example, a keyboard, a keypad, a mouse or other pointing device, a microphone, knob or a switch, an infra-red (IR) port, a docking station, and/or a touch screen. Input device(s) 206 may be used, for example, to enter information into computer system 200. Output device(s) 208 may comprise, for example, a display (e.g., a display screen) a speaker, and/or a printer.

Data storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. Data storage device 204 stores program instructions for execution by processor 201. This operation may initially include operation of communication device 202 to retrieve renewal validation rules 210, filing and entity selection rules 212, role and access validation rules 214, payment rules 216, and entity data 218. In some embodiments, and as described with respect to FIG. 1, data storage device 204 may comprise a data warehouse or network or cloud type storage facility or mechanism that is in communication with one or more third party databases or servers 220 and 230.

One or more public cloud, private cloud, hybrid cloud and cloud-like networks may also be implemented, for example, to store, handle and conduct processing of one or more transactions or processing of embodiments of the present invention. Cloud based computing may be used herein to handle any one or more of the application, storage and connectivity requirements of embodiments of the present invention. For example one or more private clouds may be implemented to handle entity renewal and compliance data of embodiments of the present invention. Furthermore, any suitable data and communication protocols may be employed to accomplish the teachings of embodiments of the present invention.

Data storage device 204 may store other data used and/or generated during operation according to some embodiments. For example, the data storage device 204 may store data including entity identification data, renewal related rules, or the like. The nature and usage of this stored data according to some embodiments will be described in detail below. Each of the rules stored in the system 200 may include data defining an entity renewal requirement or supplemental information.

In some embodiments, rules associated with renewal validation may be specified as renewal validation rules 210. Renewal validation rules 210 may specify the mode, type and frequency of renewals for various jurisdictions and territories.

In some embodiments, rules associated with filing of certificates of authority, agency licenses, annual reports and third party administrator licenses may be specified as filing rules 212. Filing rules 212 may specify the forms, manner, and timing of new and renewal licenses that may be made in each state as well as rules around optimizing selection of entities and licenses to be created or renewed.

In some embodiments, rules associated with roles and access for the present system may be specified as role and access validation rules 214. Role and access validation rules 214 may relate to standards and guidelines used in determining whether a user is authorized to file a certain renewal and what type of renewal such as certificates of authority, agency licenses, annual reports and third party administrator licenses.

In some embodiments, rules associated with payment may be specified as payment rules 216. Payment rules 216 may relate to certain standards and requirements for filing of renewal licenses such as payment by check, credit card, electronic fund transfer, wire transfer, procurement card, etc.

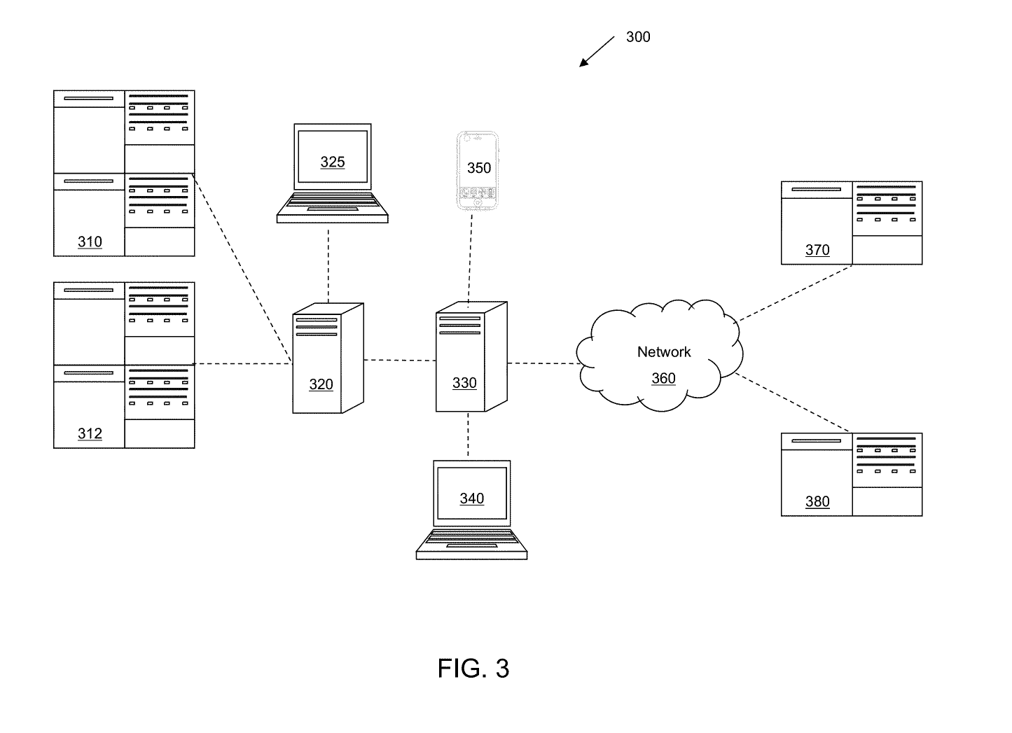

Referring now to FIG. 3, an exemplary entity license renewal processing architecture is shown. Although some devices of architecture 300 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 3, data servers 310-312 store policy information associated with one or more insurance entities that transact business in one or more states such as may be authorized by one or more certificates of authority, agency licenses, annual reports and third party administrator licenses. Each of the entity data servers 310-312 may comprise any combination of hardware and/or software, including but not limited to relational databases, application servers, and spreadsheets. One or more of entity data servers 310-312 may comprise a data warehouse of an insurance company or any other aggregator of insurance entity information.

Each of entity data servers 310-312 may provide entity data information to system 320 asynchronously or according to any schedule. In some embodiments, one or more of entity data servers 310-312 provides a daily feed of entity data information to system 320. The entity data information of the feed may be associated with new or renewal licenses for any entity and for any jurisdiction.

System 320 may comprise any combination of hardware and software to perform processes as described herein. System 320 may comprise program instructions of a database management system, database procedures and/or database applications to process the data stored at those systems or retrieved by those systems. One or more administrator terminals or device 325 may be in communication with system 320 and configured to provide display screens representing data stored in system 320 and options to permit an operator to edit this data and to otherwise provide commands to system 320. For example, an administrator terminal or device 325 may be configured to permit an operator to input commands via a user interface to update a data structure including information associated with a claim or the like. Terminal 325 may comprise any suitable device including one or more input devices, such as keyboards, touchscreens and pointing devices, and display devices such as display screens, including but not limited to a desktop computer, tablet computer, and/or smartphone.

Entity management system 330 may receive entity license records and associated information from system 320. In this regard, authorized users may operate terminal 340 or device 350 to access the records of entity management system 330. All terminals described herein may comprise any suitable devices for requesting and displaying user interfaces, including but not limited to desktop computers, cellular telephones, personal digital assistants, and laptops.

Entity management system 330 may be in further communication via a network 360 (e.g., the Public Switched Telephone Network, a cellular network, and/or an Internet Protocol network) with one or more third party servers 370 and 380

In some embodiments, server 320 may also include a notification module or code administering and applying notification and messaging rules associated with entity renewals pursuant to the present invention. For example, the notification module may operate to generate one or more notifications to users that may be responsible for certificates of authority, agency licenses, annual reports and third party licenses for particular jurisdictions. As a specific example, all active entity licenses may be monitored to identify any upcoming “trigger” events or dates, such as the expiration or activation of a license in a particular state or jurisdiction.

A number of notifications may be generated using the notifications code of server 320. These notifications may vary depending on the requirements of the particular certificates of authority, agency licenses, annual reports and third party licenses such as whether to issue a notification a certain time period before expiration of the license. For example, automated notifications/reminders via email, text or otherwise of may be generated such as upon a predetermined date before the expiration of the license such as 15, 30, 45, 60 or 90 days.

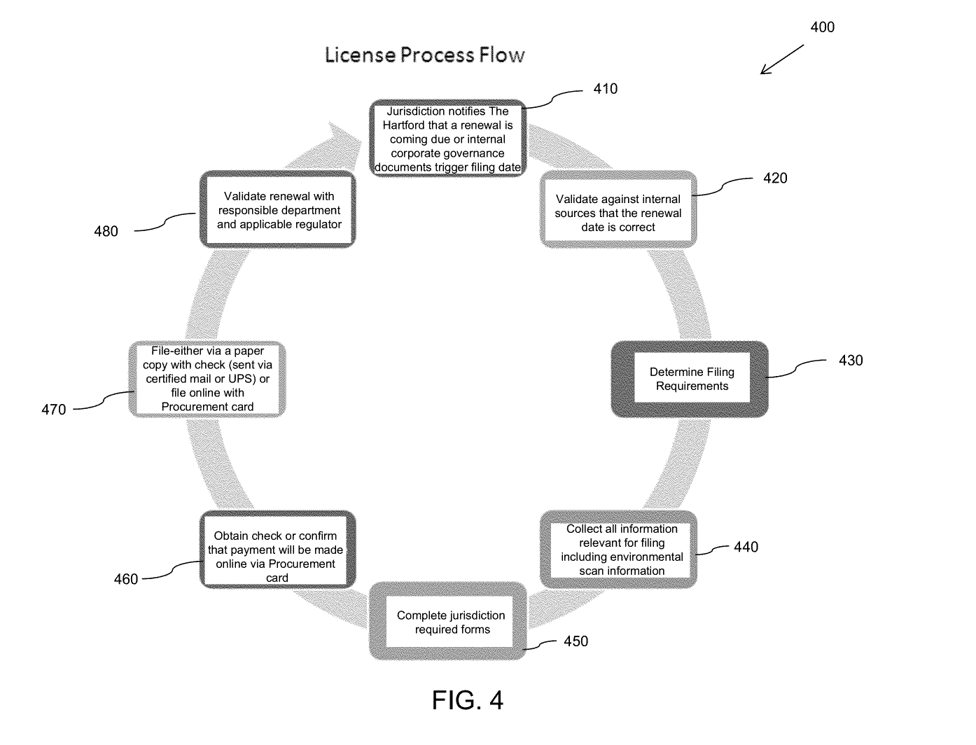

FIG. 4 is a flow diagram of a computer-implemented process 400 according to some embodiments. Various elements of system architecture 300 may execute process 400 according to some embodiments. Process 400 may be embodied within program instructions of license management system 330, but embodiments are not limited thereto. Process 400 and all other processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

Process 400 may be performed in response to a notification received by a user such as a member of a business, finance, tax or legal department of an insurance entity. Processing begins at 410 where an insurance entity is notified that renewals are coming due for a certain entity license. Processing continues at 420 where the renewal requirement is validated against internal sources that the renewal data is correct. Processing continues at 430 where the filing requirements are determined for the entity renewal. Processing continues at 440 where information to fulfill the filing requirements is collected. Processing continues at 450 where the forms for the entity renewal are completed. Processing continues at 460 where payment information is configured and validated. Processing continues at 470 where payment is effected via a variety of payment methods. Processing continues at 480 renewal is validated with the responsible department and applicable regulator.

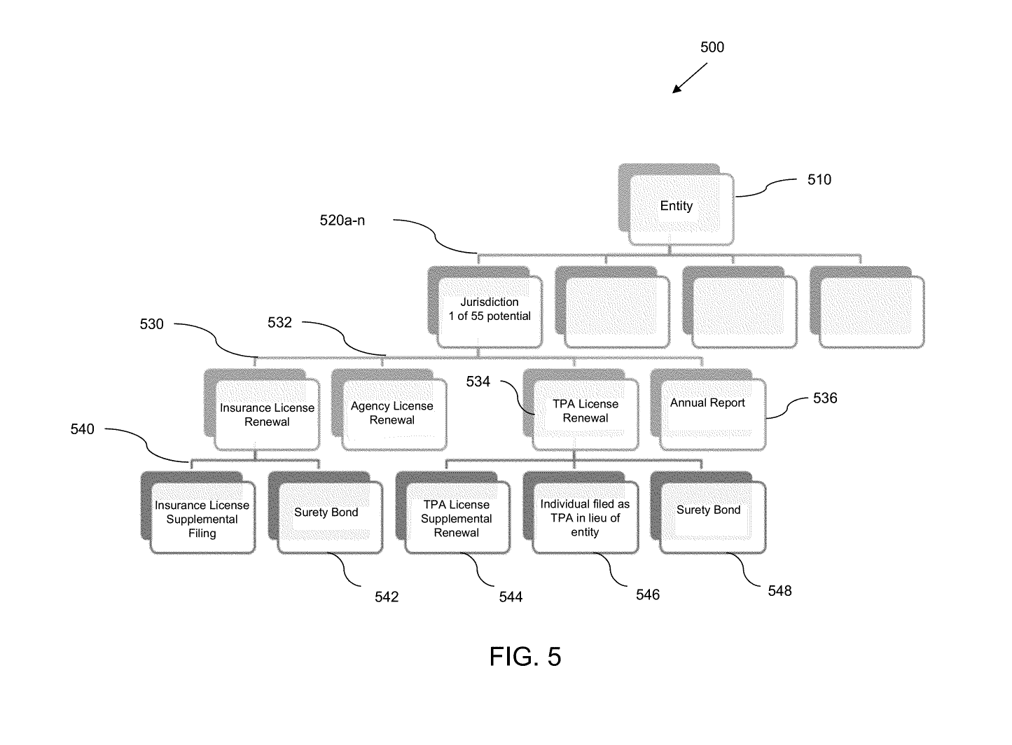

Reference is now made to FIG. 5 which is visual representation of a sample data hierarchy 500 within a license entity system according to at least one embodiment of the present invention. Data hierarchy 500 comprises at least one entity 510. An entity may be representative of an 1) insurance entity that issues insurance products; 2) an agency that solicits, sells, and offers insurance products; 3) a business that wants to do business in states in which the entity is not incorporated; and/or 4) a third party administrator that performs administrative services. Entity 510 may have association with one or more jurisdictions 520a-n that may be representative of certain states or territories. Each of jurisdictions 520a-n may be associated with at least one of an insurance license renewal 530, an agency license renewal 532, a third party administrator license renewal 534 and an annual report 536. Each of jurisdictions 520a-n may be associated with one, all or any combination of an insurance license renewal 530, an agency license renewal 532, a third party administrator license renewal 534 and an annual report 536. Insurance license renewal 530 may be associated with an insurance license supplemental filing 540 and/or a surety bond 542. Insurance license supplemental filing 540 may be associated with a jurisdiction such as Massachusetts or other jurisdiction. Third party administrator renewal 534 may be associated with a third party administrator license supplemental renewal 544, an individual filed as a third party administrator in lieu of entity 546 and a surety bond 548. Other data fields or records are contemplated within hierarchy 500 such as inclusion of a distribution report and/or a utilization report for certain jurisdictions such as Nevada or other jurisdictions.

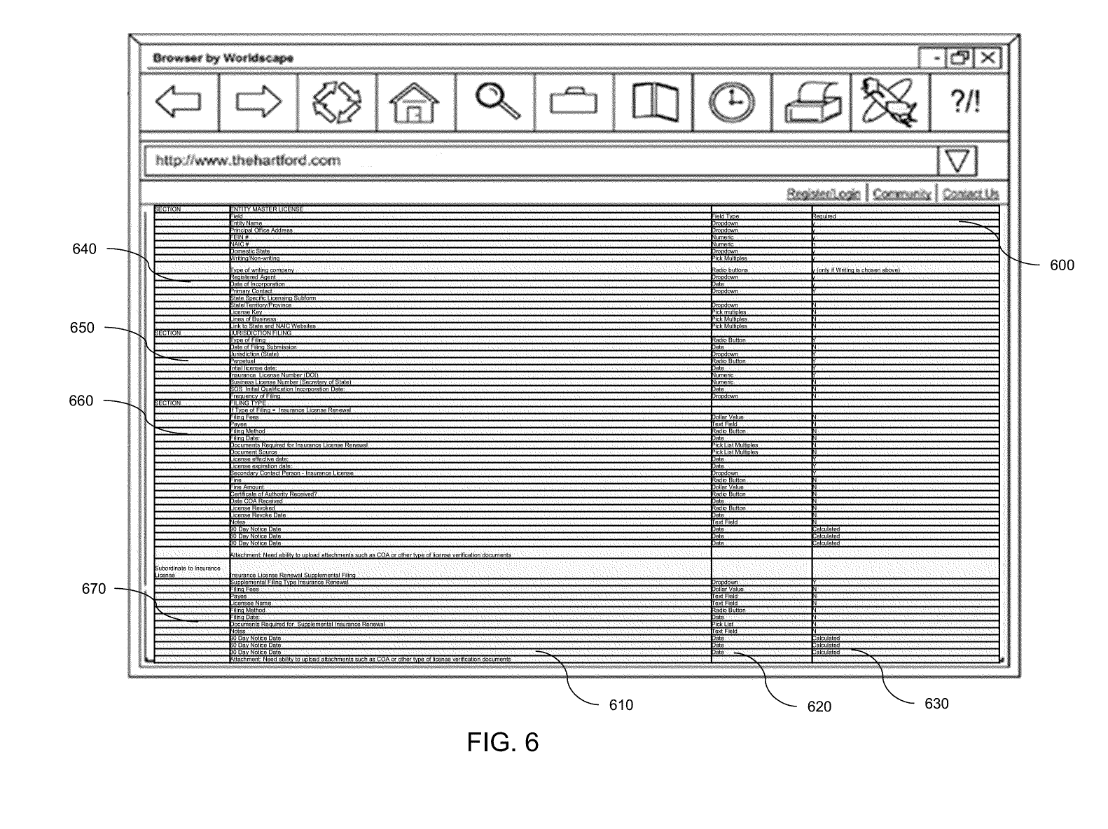

Reference is now made to FIG. 6 which is a tabular representation of a portion of an exemplary entity license record 600. Entity license database record 600 includes a number of data fields representing data associated with one or more licensed entities. Several fields are identified for each license record for convenience and ease of exposition—those skilled in the art will appreciate that a typical record may have more fields and data elements. Some or all of the data populating entity license database record 600 may be obtained or generated such as by the system 100 of FIG. 1, during a license renewal process or insurance process.

Embodiments are not limited to the fields shown in FIG. 6, and each data field need not be populated in some embodiments. Database record 600 may also be tagged, relational or linked. Database record 600 may be used to record a license renewal such as may be described herein. Entity license record may contain columns 610, 620 and 630 that correspond to certain fields, field types and requirements. Columns 610, 620 and 630 may correspond to certain record sections 640, 650, 660 and 670. Record sections 640, 650, 660 and 670 may correspond to sections such as an entity master license section, a jurisdiction filing section, a filing type section and an insurance license renewal supplemental filing section. Fields such as Entity Name, Principal Office Address, FEIN #, NAIC #, Domestic State, Writing/Non-writing, Type of writing company, Registered Agent, Date of Incorporation and Primary Contact may be associated with record section 640. Fields such as Type of Filing, Date of Filing Submission, Jurisdiction (State), Perpetual, Initial license date, Insurance License Number (DOI), Business License Number (Secretary of State), SOS Initial Qualification Incorporation Date: and Frequency of Filing may be associated with section 650. Fields such as Filing Fees, Payee, Filing Method, Filing Date:, Documents Required for Insurance License Renewal, Document Source, License effective date:, License expiration date:, Secondary Contact Person—Insurance License, Fine, Fine Amount, Certificate of Authority Received?, Date COA Received, License Revoked, License Revoke Date, Notes, 90 Day Notice Date, 60 Day Notice Date, and 30 Day Notice Date may be associated with section 660. Fields such as Supplemental Filing Type Insurance Renewal, Filing Fees, Payee, Licensee Name, Filing Method, and Filing Date, Documents Required for Supplemental Insurance Renewal, Notes, 90 Day Notice Date, 60 Day Notice Date and 30 Day Notice Date may be associated with section 670. Other fields may be provided within the present system including Supplemental Filing Type TPA, Filing Fees, Payee, Licensee Name, Filing Method, Filing Date:, Documents Required for Supplemental TPA Renewal, Notes, TPA License Surety Bond Renewal, Surety (Name of entity issuing the bond), Bond Amount, Bond Cost, Bond Expiration Date, Bond Renewed, Bond Contact Person and Notes, among others in the present invention.

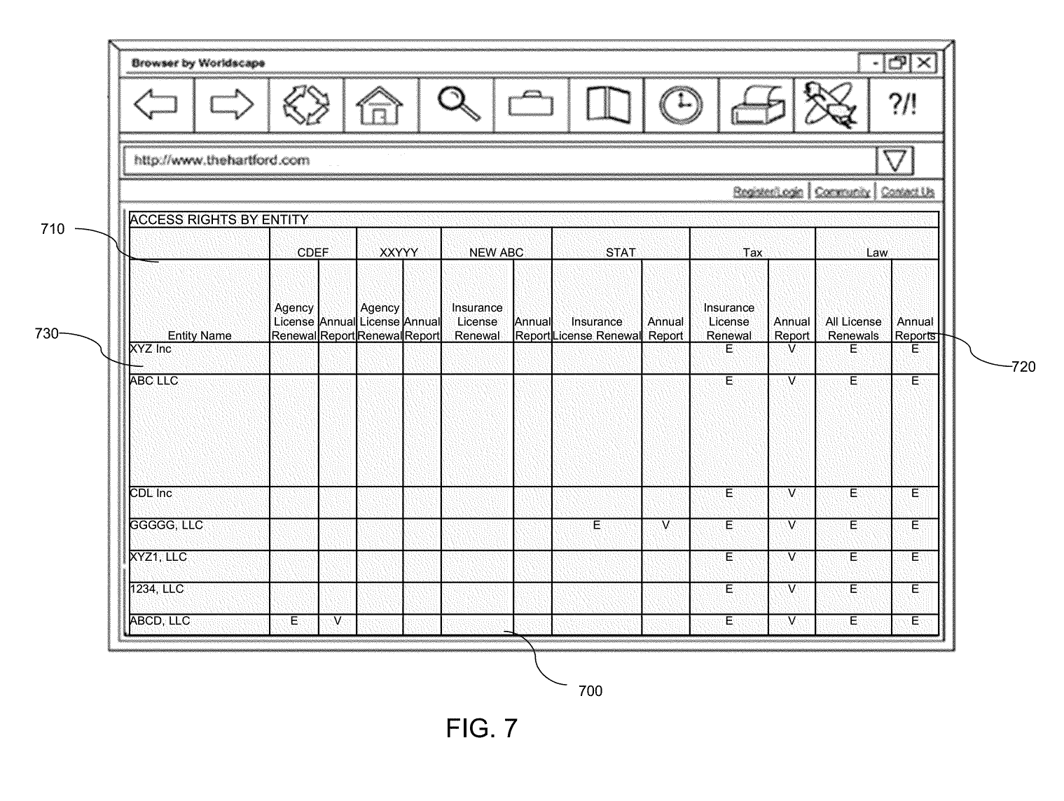

Reference is now made to FIG. 7 which is a tabular representation of an exemplary access rights table 700 for entity license filing. Exemplary access rights table 700 includes a number of data fields representing access rights by entity for one or more licensed entities. Several fields are identified for convenience and ease of exposition—those skilled in the art will appreciate that a typical table may have more fields and data elements. Some or the entire data populating exemplary access rights table 700 may be obtained or generated such as by the system 100 of FIG. 1. Embodiments are not limited to the fields shown in FIG. 7, and each data field need not be populated in some embodiments. Database record 600 may also be tagged, relational or linked. Exemplary access rights table 700 may include an identification of departments or organizations 710 that are authorized to perform certain license renewals 720 for certain entities 730. For example, within exemplary access rights table 700 a certain department like a Tax department may be authorized to access insurance license renewals and annual reports for a variety of entities.

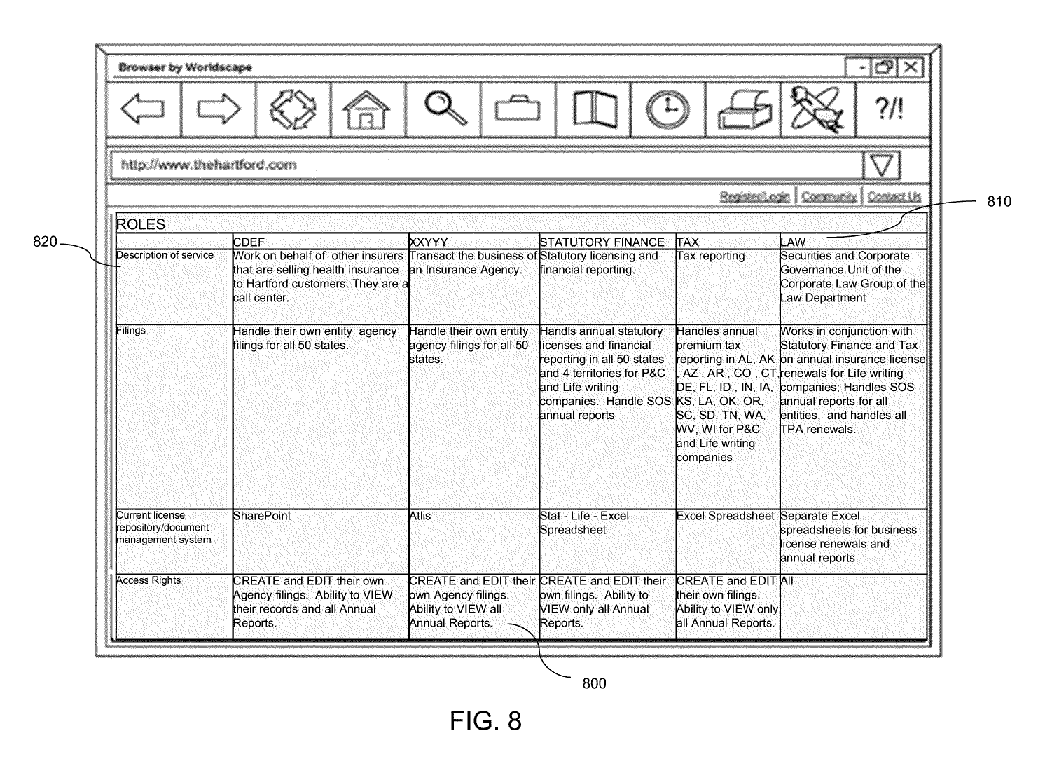

Reference is now made to FIG. 8 which is a tabular representation of an exemplary department role allocation table 800 for entity license filing. Exemplary roles table 800 includes a number of data fields representing roles of various departments such as statutory finance and law 810. Several fields are identified for convenience and ease of exposition—those skilled in the art will appreciate that a typical table may have more fields and data elements. Some or the entire data populating exemplary access rights table 800 may be obtained or generated such as by the system 100 of FIG. 1. Embodiments are not limited to the fields shown in FIG. 8, and each data field need not be populated in some embodiments. Exemplary department role allocation table 800 may include descriptions 820 of various roles for each department that may be utilized by the present system to control and provide access and filing authorization.

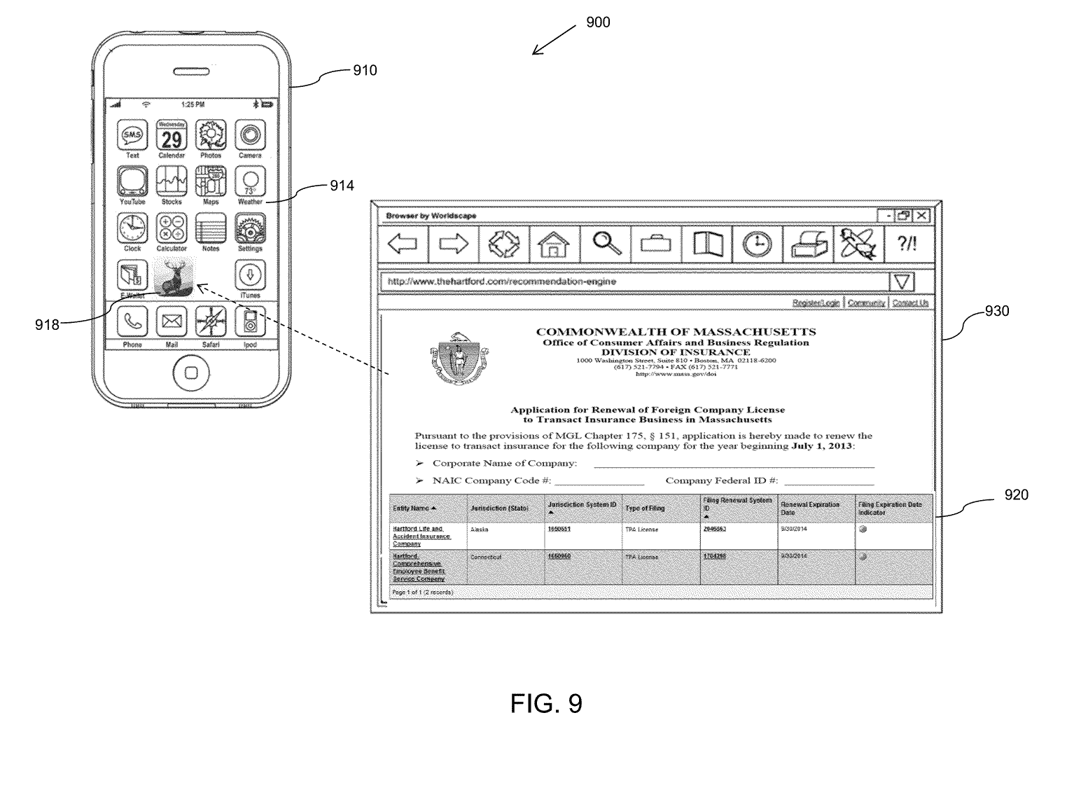

An illustrative example of a system 900 including a user device 910 accessing a user interface 914 for the management of entity licenses is shown at FIG. 9. User interface 914 may be app type screen that provides access to an insurance company system. As shown, The Hartford app 918 is configured to provide a user interface 920 that may display an application form 930 for access to entity license data. Application form 930 may be used to complete a certificate of authority, business license, agency license and/or third party administrator license as well as access existing license records. Those skilled in the art will appreciate that a wide variety and type of user interfaces may be provided, and that the system 900 is provided for illustrative purposes only.

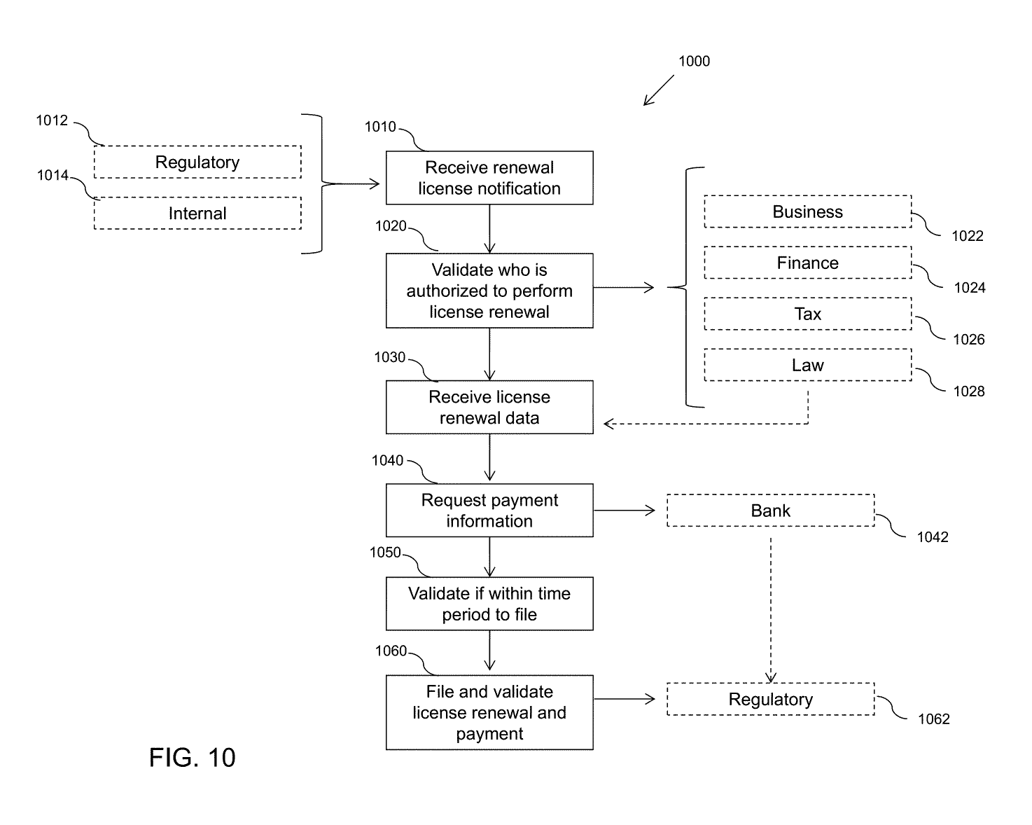

FIG. 10 is a flow diagram of a computer-implemented process 1000 according to some embodiments. Process 1000 may be embodied within program instructions of the present entity license management system, but embodiments are not limited thereto. Process 1000 and all other processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompelled and/or encrypted format. In some embodiments, hard-wired circuitry may be used in place of, or in combination with, program instructions for implementation of processes according to some embodiments. Embodiments are therefore not limited to any specific combination of hardware and software.

Process 1000 begins with the receipt of a license notification 1010 from one or both of a regulatory authority 1012 or an internal trigger 1014. Process 1000 continues with validation of a license renewal user 1020 from at least one of a business user 1022, a finance user 1024, a tax user 1026 and/or a law user 1028. Process 1000 continues with license renewal data being received from at least one of the validated user 1030. Process 1000 continues with payment being requested 1040 from a banking institution 1042. Process 1000 continues with validating if it is within the proper time period, such as 30/60/90 days to file the renewal 1050. Process 1000 continues with filing and validating the license renewal and payment 1060 with at least one regulatory authority 1062.

The embodiments described herein are solely for the purpose of illustration. Those in the art will recognize that other embodiments may be practiced with modifications and alterations limited only by the claims. For example, though the methods and features described above with reference to FIGS. 1-10 are described above as performed using the example architecture 100 of FIG. 1 and the exemplary system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-10 may be used alone without the other features and elements or in various combinations with or without other features and elements. Sub-elements of the methods and features described above with reference to FIGS. 1-10 may be performed in any arbitrary order (including concurrently), in any combination or sub-combination.

What is claimed is:

1. A computer system for processing and tracking entity license input data with a third party data system, comprising:
one or more data storage devices storing data indicative of entity license compliance guidelines for a plurality of jurisdictions and entity license data for a plurality of related entities;
one or more computer processors; and
a memory storing computer-readable instructions, which instructions, when executed by the one or more computer processors, cause the one or more computer processors to:
periodically determine if one or more licensed entities have entered a period of license renewal;
output a validated notification related to the one or more licensed entities that have entered the period of license renewal;
output an entity license data user interface including a plurality of data fields for entry and viewing of entity license data for display on a display device;
validate a user for proper access credentials;
receive data associated with at least one licensed entity in at least one jurisdiction via the user interface for the validated user;
retrieve entity compliance guidelines from the one or more data storage devices, based on the received data;
modify an electronic record associated with the at least one licensed entity;
populate one or more data fields included in the user interface with updated data related to the at least one licensed entity; and
schedule at least one future electronic notification based on the populated data fields, the notification based on at least one regulatory authority guideline issued by a state department of insurance.

2. The computer system of claim 1, wherein the license data relates to two or more of Certificates of Authority, agency licenses, business licenses and third party administrator licenses.

3. The computer system of claim 2, wherein the license data relates to three or more of Certificates of Authority, agency licenses, annual reports, third party administrator licenses and supplemental filing information.

4. The computer system of claim 1, further comprising: selecting a writing company entity based on a plurality of selection factors.

5. The computer system of claim 1, wherein the user is affiliated with at least one of a law group, an agency group, a tax group and a finance group.

6. The computer system of claim 1, wherein validating a user for proper access credentials comprises determining which one or more of a of Certificates of Authority, agency licenses, annual reports and third party administrator license the user is authorized to renew.

7. The computer system of claim 1, wherein the instructions further cause the one or more computer processors to generate a text based notification to an authorized user for a specific entity license.

8. The computer system of claim 1, wherein the instructions further cause the one or more computer processors to generate an electronic mail based motivation.

9. The computer system of claim 1, wherein the instructions further cause the one or more computer processors to determine if a record has already been started for a given renewal.

10. A computer-implemented method for generating and displaying one or more interactive user interfaces for entity renewal tracking, comprising:
outputting by one or more computer processors to a display device an entity renewal data collection user interface including a plurality of data fields for entry of information about an entity renewal for display on a display device;
receiving, by the one or more computer processors, first data associated with the entity renewal via the user interface;
retrieving, by the one or more computer processors, from one or more data storage devices storing data indicative of entity renewal guidelines for a plurality of jurisdictions;
issuing, by the one or more computer processors, a renewal notification to one or more authorized entities;
determining, by the one or more computer processors, from the one or more data storage devices, filing requirements for the one or more entity renewals;
receiving, by the one or more computer processors, data from one or more users via the user interface;
populating, by the one or more computer processors, one or more renewal related forms via the user interface;
requesting, by the one or more processors, payment data related to the one or more renewal related forms;
submitting, by the one or more computer processors, the populated renewal forms and payment data to one or more third party systems; and
adjusting, by the one or more computer processors, one or more entity records based on the submitted forms and data.

11. The computer-implemented method of claim 10, further comprising validating the one or more users.

12. The computer-implemented method of claim 10, wherein the payment data is an electronic fund transfer for a state filing fee.

13. The computer-implemented method of claim 10, wherein the third party system is a secretary of state office system.

14. The computer-implemented method of claim 10, wherein the third party system is a state department of insurance system.

15. A computer system for generating and displaying one or more entity renewal forms and processing renewal input data, comprising:
a renewal processing user terminal;
a first computer system in communication with the renewal processing terminal, the first computer system comprising:
one or more data storage devices storing data indicative of entity renewal guidelines for a plurality of jurisdictions and policy data for a plurality of auto insurance policies;
one or more computer processors; and
a memory storing computer-readable instructions, which instructions, when executed by the one or more computer processors, cause the one or more computer processors to:
output an entity renewal data collection user interface including at least one data field for input of information about an entity renewal for display on a display device of at least one of the renewal processing terminal;
validate a user for the entity renewal data collection user interface;
receive third party renewal data from the validated user for a specific license type;
validate third party renewal data;
determining renewal filing requirements;
receive renewal data via the user interface;
request renewal payment data;
submit renewal data and payment data to a third party system; and
validate renewal data and payment data.

16. The computer system of claim 15, wherein validated a user for the entity renewal data collection user interface comprises determine a user's role relative to a renewal filing.

17. The computer system of claim 16, wherein the license type is determined by a nature and type of business conducted by each entity.

18. The computer system of claim 16, wherein the license type is at least two of a certificate of authority, an agency license, an annual report and a third party administrator license.

19. The computer system of claim 18, further comprising validating multiple users for a single license type.

20. The computer system of claim 15, further comprising optimizing a selection of a writing company for placement of new business in a jurisdiction.
